(19) United States
(12) Patent Application Publication
(10) Pub. No.: US 2026/0284492 A1
(43) Pub. Date: Sep. 24, 2026

(54) SECONDARY LAYER ASSEMBLY FOR AN IMPACT SURFACE AND METHOD THEREOF

(71) Applicant: GEAR TIES LLC D/B/A XTRUDEX, Fridley, MN (US)

(72) Inventor: DANIEL MARTINSON, Fridley, MN (US)

(73) Assignee: GEAR TIES LLC D/B/A XTRUDEX, Fridley, MN (US)

(21) Appl. No.: 19/475,063

(22) PCT Filed: Apr. 22, 2024
(86) PCT No.: PCT/US2024/025743

§ 371 Date: Oct. 14, 2025

Related U.S. Application Data
(60) Provisional application No. 63/497,210, filed on Apr. 20, 2023.
(60) Provisional application No. 63/582,875, filed on Sep. 15, 2023.
(60) Provisional application No. 63/548,389, filed on Nov. 14, 2023.

(51) Int. Cl. A63B 59/45; A63B 102/08; C09J 7/38

(52) U.S. Cl. CPC A63B 59/45; C09J 7/38; A63B 2102/08; A63B 2209/10; C09J 2203/37; C09J 2301/122; C09J 2301/302; C09J 2301/502; C09J 2469/00; C09J 2475/00

(57) ABSTRACT

A multi-layer secondary film assembly to be removably couplable to a surface of an apparatus. The secondary film assembly can include at least two layers, including a film layer and an adhesive layer. The film layer can be comprised of any suitable material, including but not limited to a PET, TPU, or polycarbonate material. The first side of the film layer can have a textured surface having a first coefficient of friction against an object that impacts the first surface of the film layer to provide a desired spin against the object. A second side of the film layer can have a smooth or flat surface with a second coefficient of friction. The adhesive layer can be any suitable material, including but not limited to a pressure sensitive adhesive. The adhesive layer can be a singular non-differential and/or non-supported adhesive layer.

### CROSS-REFERENCE TO RELATED APPLICATION

This Patent Application claims priority to U.S. Provisional Application: 63/497,210 filed Apr. 20, 2023, U.S. Provisional Application: 63/582,875 filed September 15, 20242023, U.S.

Provisional Application: 63/548,389 filed Nov. 14, 2023, and U.S. Provisional Application: 63/548,391 filed Nov. 14, 2023 the disclosures of which is considered part of the disclosure of this application and is hereby incorporated by reference in its entirety.

### FIELD OF THE INVENTION

This present disclosure relates generally to a gaming paddle assembly, such as a pickleball paddle, and method of making the same. In another aspect the present disclosure relates to a film or film assembly applied to an exterior surface of the paddle assembly.

### BACKGROUND

The sport of pickleball has grown rapidly over the last ten years. Many racquet clubs have added pickleball courts and programs to their facilities. The USA Pickleball Association (or “USAPA”) has been formed as a governing body in the United States. Internationally, the International Federation of Pickleball (or “IFP”) serves as a governing body for international competition. Together, the USAPA and the IFP publish a rules book.

In the gaming paddle industry, there are various types of paddle assemblies and methods of creating the same. One primary method is for a paddle assembly to be comprised primarily of a core portion and an exterior extruded and protective portion to protect the outer edge of the core portion from wear and contact with the ground. The exterior protective portion is typically extruded in a single piece and the glued or adhered to the outer edge of the core portion of the paddle. This assembly results in a fairly poor construction and can be somewhat labor intensive. In the majority of paddle models, the handle portion is added to the paddle assembly separately to the head portion creating a very weak point in the paddle construction that can lead to deterioration of the paddle and eventual failure.

Additionally, more labor and expensive techniques can include the application of a carbon fiber material being wrapped around a core and heat sealed to form a protective outer shell. All current paddle assemblies on the market are comprised of varying materials preventing the ability for them to be recycled and resulting in waste. Similarly, the use of different materials results in increased costs, can lead to a higher likelihood of delamination of the various materials from each other, and the inability to reuse the materials as they cannot be separated from each other.

Furthermore, the impact surface of a paddle can become worn down and result in decreased performance of the paddle. Traditionally, the paddle would have to be completely replaced. Recently, some companies are starting to utilize a secondary wear layer that can be applied aftermarket to a paddle assembly. The system described in U.S. Pat. No. 11,925,843 not only requires cumbersome components such as a tab that adds further balance and weight issues, but also includes use of materials and technology that result in increased weight that negatively affect the performance of the paddle and fail to suitable solve the issues of the worn wear layer without introducing additional negative impacts to performance.

Specifically, the utilization of multiple layers of differential adhesive results in additional weight of the paddle thereby decreasing the feel and performance by the user. Traditional PSA adhesives generally utilize a three-layer system consisting of a first PSA having a first binding affinity, a carrier layer, and a second PSA having a second binding affinity. One side of the film has a permanent PSA chemistry, and the other side of the film has a removeable PSA chemistry. The problem with this type of construction is weight. The traditional differential adhesive methods that utilize products such as 3M 9425HT result in an adhesive layer actually comprised of two different adhesives and a carrier film to separate each adhesive that adds additional unwanted thickness and weight. The 3M 9425HT the total thickness of about is 4.2 mil. This thickness adds a prohibitive amount of weight to the paddle resulting in a higher swing weight and a higher overall paddle weight that can result into up to three times the amount of adhesive and therefore weight which negatively affects the playability of the paddle.

Other similar construction methods as shown in Nygren (U.S. Patent Application 20020266106) are not realistic for a pickleball paddle. The resulting weight of this 19.9 mil assembly will be prohibitive when the final laminate is adhered to a pickleball paddle. On a typical 70 square inch paddle face, this would add over 0.70 ounces to each face of the paddle based on the density of the adhesives, laminate, and vinyl film. A typical pickleball paddle weights between 7.4 and 8.4 oz. Adding a total of 1.4 oz of weight to the paddle will result in a paddle that is too heavy with a very high swing weight. This surface plate thickness also has the potential to change the paddle characteristics when hitting a pickleball. And, this design does not provide a differential bond between the “protector shield” and the paddle face. The design requires a “removeable adhesive.” However, without a differential adhesive system as described in prior art #2, this method of construction will cause PSA bond “confusion”. This occurs when the “protector shield” is removed from the paddle face and some of the PSA remains on the paddle face instead of releasing cleanly because the surface energy of the paddle face is greater than the surface energy of the vinyl film.

Additionally, the surface face of a paddle has one primary purpose: to provide a surface that creates ball spin when the paddle hits the pickleball. All pickleballs are made from high density polyethylene (HDPE). HDPE is a very hard polymer and has a very low surface energy that makes it slippery. Therefore, the surface of the paddle face needs to have a high coefficient of friction (COF) against the surface of the ball to achieve high ball spin rates when the paddle hits the pickleball. Typically, this is achieved by using a rough textured surface with a very high hardness, such as raw carbon fiber resin with a peel ply texture or a hard particulate that is spray applied to the paddle surface with a polymer binder (paint). The geometry of the texture and/or particulate bites into the ball to create spin. Additionally, the carbon fiber materials and sprayed textures can be worn down over time from contacting objects, such as a pickle ball made from HDPE resulting in reduced performance over time.

A high surface COF between the ball and the paddle surface face can also be achieved by using a smooth surface or surface with a low roughness made from a material with grippy or rubber-like properties such as TPU and elastomer coatings, however, those materials are typically very thick with little structure. In this case, the surface can be smooth because the COF between the ball and the paddle surface face is not relying on a texture to “bite” into the ball to create spin but rather the grippy or tacky properties of the material or coating causes the ball to stick to the paddle face when it makes contact known as having a high residence time.

Both of these techniques create additional challenges in the design of a paddle surface. Typically, high hardness polymers have poor abrasion resistance. Therefore, the geometric texture will wear down and ball spin will be reduced as can be found with carbon fiber resin and sprayed-on particulate textures. Extruded polymer films with textured surfaces are another option to create a paddle surface that will result in ball spin. However, these types of materials will also wear down over time. Smooth and tacky rubber-like surface materials with a high COF between the ball and paddle surface face are usually made from a thermoplastic or thermoset elastomer that can be applied to the surface of the paddle, however, these material are typically a lower durometer/hardness. The materials are extruded at a thickness of 7 mils or less to limit the effect on paddle weight and swing weight, low durometer thin flexible films become cumbersome to handle and difficult to apply to the face of the paddle because of the lack of structure and rigidity. To solve this problem, the thickness of the flexible film needs to be increased to give the extruded film more structure, however, this results in a skin or film that is too heavy for the application resulting in poor playability and performance of the paddle.

Traditional paddles have a high noise level upon impacting a ball. In order to reduce the noise created by ball impacts, some parties have started redesigning an entire paddle assembly of specific materials to lower the decibels and frequency of ball impacts. This leads to a more cumbersome design and also renders current paddles used by players useless requiring them to purchase an additional paddle for desired noise reduction when playing in noise restricted areas.

Therefore there exists a need to provide a thin film assembly having a certain rigidity to allow for easy application of a film assembly as well as providing a durable wear layer with a high COF between the ball and paddle surface face and to provide spin against a contacting object that can be removably coupled to a paddle assembly without adding excessive weight. Additionally, there is a need for a secondary film assembly that can be applied to preexisting paddles to provide noise reduction while not negatively impacting the playability of a sports implements such as a paddle.

Furthermore, there exists a need for an improved paddle assembly to provide more efficient construction and performance of a paddle. Moreover, there is a need for an improved paddle assembly for regulation paddle surfaces that can be added later or replace worn out paddle surfaces without negatively impacting characteristics of the preexisting paddle.

### BRIEF SUMMARY OF THE INVENTION

This summary of the invention is to provide an overview of various concepts described in further detail below and is not indented to be limiting the claim scope of the claimed subject matter.

In one aspect, this disclosure is related to a multi-layer secondary film assembly to be removably couplable to a surface of an apparatus. The apparatus can be a paddle surface which can have a first roughness. The secondary film assembly can include at least two layers, including a film or base layer and an adhesive layer. The film layer can be comprised of any suitable material, including but not limited to a PET, TPU, or polycarbonate material. The first side of the film layer can have a textured surface having a first coefficient of friction against an object that impacts the first surface of the film layer to provide a desired spin against the object. A second side of the film layer can have a smooth or flat surface with a second roughness. The roughness of the second side of the film layer can be less than the roughness of the paddle surface. This can allow the adhesively layer to have a higher bonding strength to the smoother second surface of the film layer rather than to the rougher surface of the paddle surface.

The adhesive layer has a thickness between 0.6 mil and 2 mil and a stiffness to prevent the adhesive layer from moving omnidirectional into one or more valleys of the textured playing surface providing a greater bonding strength to the second surface roughness than the first surface roughness. The adhesive layer can be any suitable material, including but not limited to a pressure sensitive adhesive with a thickness between about 0.6 mil and 2 mil. The adhesive layer can be a singular non-differential and/or non-supported adhesive layer coupled to the film or base layer. The secondary film assembly can further include a graphic layer positioned between the adhesive layer and the second side of the film layer. The graphic layer can be comprised of one or more layers of ink or printed material that can similarly have a less rough surface than that of the paddle surface. A coating layer can additionally be included on the first surface of the film layer. A release liner or backing layer can be coupled to the second surface of the adhesive layer to prevent dust or particles from coming into contact with the adhesive layer. In some exemplary embodiments, the release liner can just have a textured surface or a silicone surface to have less binding affinity to the release liner. The secondary film assembly can have a total weight between 0.1 and 0.6 oz and a thickness between 3 mil to 8 mil. The one or more graphic layers can be applied between the second surface 112 of the first layer and the adhesive layer 120, wherein each of the one or more graphic layers is between about 2 and 4 microns thick.

In another aspect, the disclosure relates to a multi-layer film assembly for removably coupling to the playing surface of a sports implement. The assembly can include a film layer having a first surface and a second surface. The film layer can include a first layer having first side and a second side and second layer having a first side and a second side. The first side of the second layer can form an exterior contacting surface. The first side of the first layer can interface with the second side of the second layer. The second side of the first layer can provide an interior bonding surface that can provide a rigid or semi-rigid carrier layer for the second layer of the film layer. The first layer can have a hardness between 50 Shore D and 150 R or between about 90 Shore D and 150R and the second portion has a hardness of between 50 Shore A and 60 Shore D. A pressure sensitive adhesive layer can be coupled to a bonding surface of the film layer. The pressure sensitive adhesive layer can be comprised of a singular layer of non-differential adhesive having only one adhesive property. Optionally, a graphic layer can be coupled to the second side of the first portion prior to the adhesive layer. The first surface of the film layer can be textured and the second surface of the film layer can be smooth. The first surface can have a COF of between 0.100 and 0.500 when tested according to ASTM D1894-14. In other exemplary embodiments, the COF can be between about 0.15 and 0.2. The second layer can additionally be comprised of a material with a high abrasion resistance with between a 2 mg and 50 mg loss based 1000 Cycles, 1000 g, CS-17 Wheel, ASTM 1044.

The multi-layer film assembly can have can have a total weight between 0.1 and 0.6 oz and a thickness between 3 mil to 8 mil. The first layer and second layer can be extruded to form the singular laminated film layer. An adhesive layer can have a thickness of between about 0.6 mil and 2 mil. In some exemplary embodiments, the remaining layers of the assembly can have a thickness between about 6 mil to about 7.4 mil. In one embodiment, a film layer can have a thickness between about 3 mil to about 7.25 mil or between about 4.5 and 6 mil. Similarly, one or more graphic layers can have a thickness between about between 2 and 4 microns thick. Multiple graphic layers can be applied to meet the printing requirements of a desired pattern and application. The graphic layers can increase the total thickness of the graphic layer 130 depending upon the number of layers applied.

In another aspect, the disclosure relates to a paddle assembly comprising a core portion having a handle portion and head portion, a first side, second side, and a sidewall forming a perimeter edge. A frame assembly having a first frame portion and second frame portion wherein each frame portion can approximate the perimeter edge of the core portion, wherein the first frame portion and the second frame portion can then be adhered together to form a barrier around the sidewall of the core portion of the assembly. The adhesive can be any type of bonding adhesive to form a rigid structure between the frame portions as well as between the frame portions and the core portion. A handle portion/over grip can then be configured to cover the handle portion of the combined first and second frames.

In another aspect, this disclosure is related to a paddle assembly comprising a core portion having a handle portion and head portion, a first side, second side, and a sidewall forming a perimeter edge. A first layer or panel can be applied to cover the first side of the core and a second layer or panel can be applied to cover second side of the core. A first frame portion and second frame portion can approximate the perimeter edge of the core portion, wherein the first frame portion and the second frame portion can then be adhered together to form a barrier around the sidewall of the core portion of the assembly. A handle portion/over grip can then be configured to cover the handle portion of the combined first and second frames. An optional secondary film assembly can then be removably coupled to each side of the paddle assembly.

In another aspect, this disclosure is related to a secondary film assembly that can be removably couplable to a surface of the core portion or a primary skin layer that is applied to the core portion utilizing an adhesive, including but not limited to a pressure sensitive adhesive (“PSA”) to couple the skin to the core portion. In one exemplary embodiment, a secondary film can be comprised of thermoplastic film and an adhesive can be utilized with a higher adhesive affinity to the thermoplastic film than to the surface of the core or skin to allow for the film to be removable from the core or skin.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of an exemplary embodiment of a paddle assembly of the present disclosure.

FIG. 2A is a perspective view of an exemplary embodiment of a paddle assembly of the present disclosure providing cutaway axis A-A along the handle and cutaway axis B-B along the head portion.

FIG. 2B is a view of the unassembled components of an exemplary embodiment of a paddle assembly of the present disclosure.

FIG. 2B is a side view of the components of an exemplary embodiment of a paddle assembly of the present disclosure.

FIG. 2C is a cross-sectional view of along axis A-A of FIG. 2A.

FIG. 2D is a cross-sectional view of along axis B-B of FIG. 2B.

FIG. 2E is a perspective view of an exemplary embodiment of an over grip portion of the present disclosure.

FIG. 3A is fully exploded perspective view of an exemplary embodiment of a paddle assembly of the present disclosure.

FIG. 3B is a partially exploded perspective view of an exemplary embodiment of a paddle assembly of the present disclosure.

FIG. 3C is a perspective view of an exemplary embodiment of a paddle assembly of the present disclosure with a removable film layer.

FIG. 4A is an illustration of an exemplary embodiment of a secondary film assembly of the present disclosure on a paddle surface.

FIG. 4B is an illustration of an exemplary embodiment of a secondary film assembly of the present disclosure on a paddle surface.

FIG. 4C is an illustration of an exemplary embodiment of a secondary film assembly of the present disclosure on a paddle surface.

FIG. 4D is an illustration of another exemplary embodiment of a film layer of a secondary film assembly of the present disclosure.

FIG. 5 is an illustration of an exemplary embodiment of a secondary film structure having two components that can be used for a secondary film assembly or first layer of the present disclosure.

FIG. 6A is an illustration of an exemplary embodiment of a secondary film assembly of the present disclosure on a release liner.

FIG. 6B is a cross-section illustration of an exemplary embodiment of a secondary film assembly of the present disclosure on a release liner along axis C-C of FIG. 6A.

FIG. 7 is an exploded view of an exemplary embodiment of a secondary film layer assembly of the present disclosure of FIG. 4D.

FIG. 8A is a perspective view of an exemplary embodiment of a paddle assembly of the present disclosure.

FIG. 8B is an exploded perspective view of an exemplary embodiment of a paddle assembly of the present disclosure.

FIG. 9 is an illustration of a cutaway view of an exemplary embodiment of a core portion of the present disclosure.

FIG. 10 is an illustration of an exemplary embodiment of a secondary film assembly of the present disclosure removably coupled to a release liner.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit, or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” or an “exemplary embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise. “A”, “an”, and “the” each may generally denote “at least one,” but does not exclude a plurality unless the contextual use dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the Figs., with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Further, it is understood that the disclosure is illustrative and exemplary of the present disclosure, and made to provide an enabling disclosure. The disclosure here is not intended to, nor is it to be construed to limit the scope of patent protection afforded in any claim of a patent issuing, which scope is defined by claims and the equivalents thereof. It is not intended that the scope of protection be defined by reading into any claim limitation found herein or issued from that does not explicitly appear in the claim itself.

Any sequence and/or order of steps of various methods or processes that are provided herein are illustrative and should not restrict the scope of the disclosure. It should be understood that, although steps of various processes or methods may be shown and described as being in a sequence or order, the steps of any such processes or methods are not limited to being carried out in any particular sequence or order, absent an indication otherwise.

The following description refers to various drawings provided. Refence numbers provided through the disclosure are used in the drawings and the descriptions provided below refer to the same or similar elements. While many embodiments of the disclosure may be disclosed, modifications and other implementations are possible. Substitution, additions, and other modification may be made to the elements illustrated in the drawings and the method described herein. The following detailed description does not limit the disclosure.

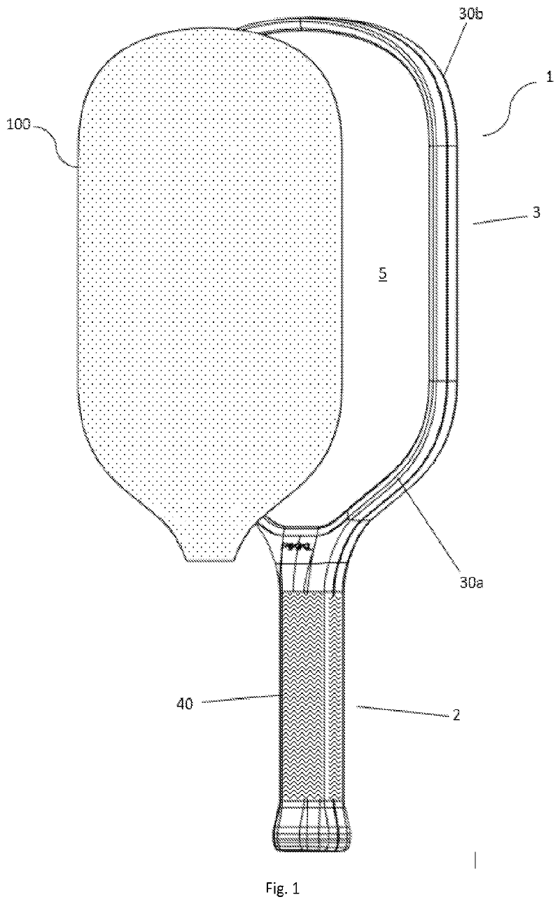

In some exemplary embodiments, a paddle assembly 1 of the present disclosure can include a handle end 2 and a paddle end 3. The paddle end can have a paddle surface 5 on opposing sides of the paddle 1. The paddle surface 5 can in most cases be a playing surface for contacting an object. In some exemplary embodiments, the paddle surface 5 can have a prescribed texture and/or roughness. A paddle assembly 1 of the present disclosure can comprise a core portion 20 and one or more bumper or frame portions 30 as illustrated in FIG. 1. The one or more frame portions 30a,b can be comprised of any suitable material such as a plastic, polymer, or composite. In some exemplary embodiments, a polypropylene material or TPU material can be used for the frame portions 30. Similarly, in some exemplary embodiments, the core portion 20 can be comprised of polypropylene or TPU. A secondary film assembly 100 can optionally be coupled to the surface 5 of the head end 3 of the core portion 20. In some exemplary embodiments, the secondary film assembly 100 can be removably coupled to allow a user to easily apply and remove the secondary film assembly 100. The secondary film assembly 100 can allow a user to easily apply a new wear surface to a paddle surface that has been worn. In some exemplary embodiments, the secondary film assembly 100 can have graphics to provide a new ornamental aspect to a paddle surface 5.

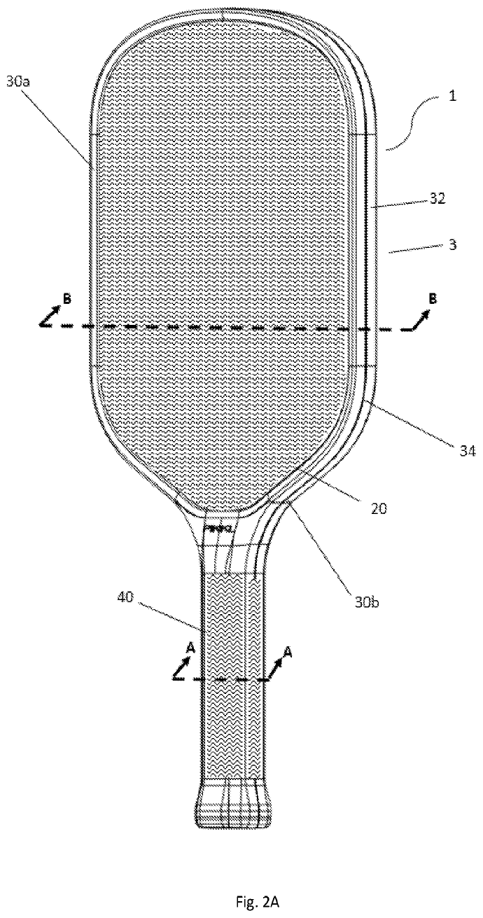

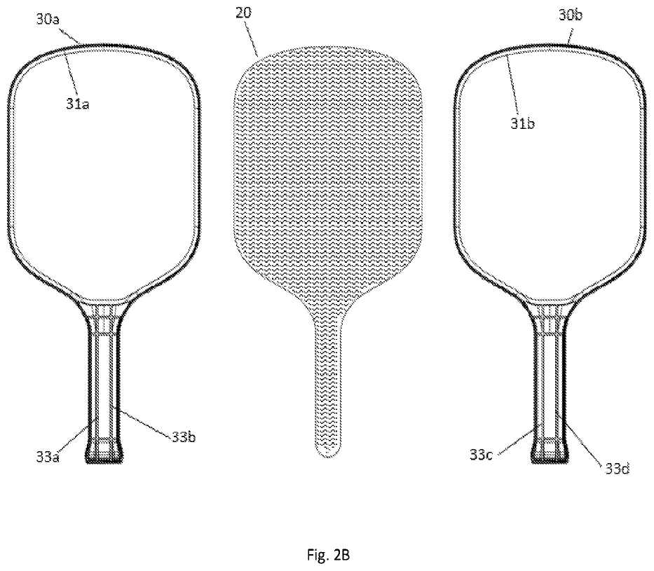

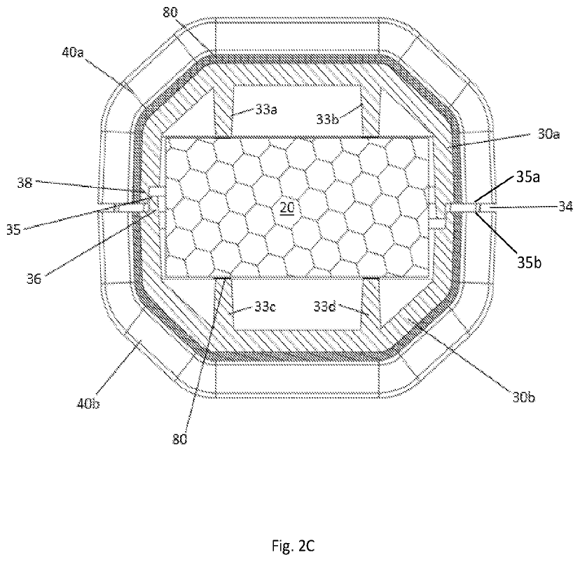

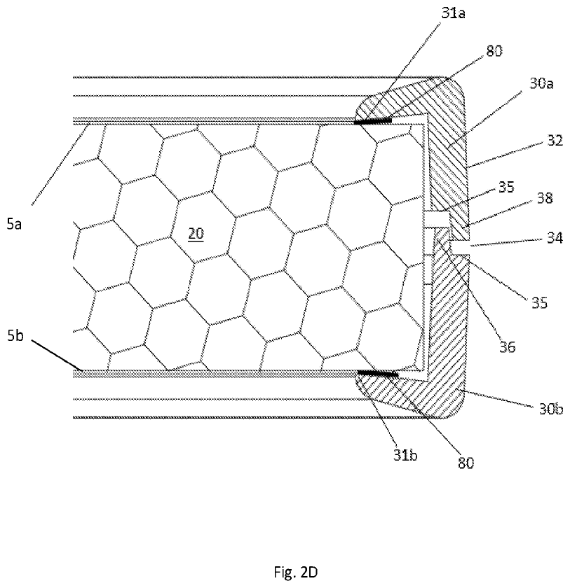

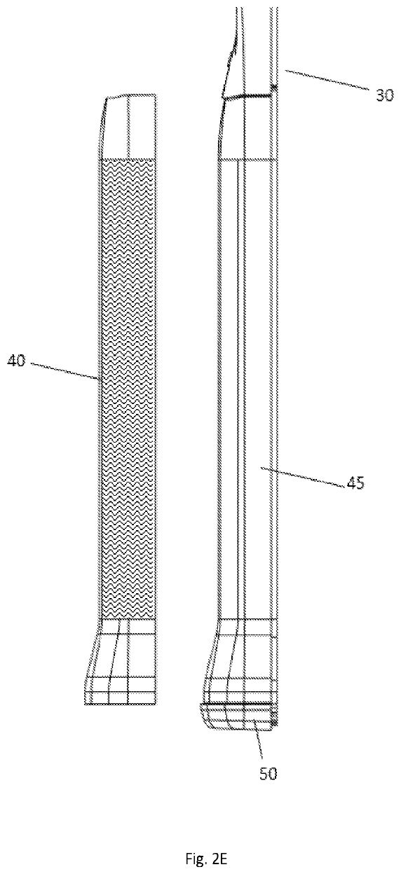

The handle portion 2 of the frames 30a, b can have one or more structural ridges 33 that can provide greater support and torsional rigidity to the paddle assembly 1 as shown in FIG. 2B-C. The ridges 33 can additionally provide another point of contact between the frame portions 30 and the core 20 where an adhesive can be utilized to couple the components together. In some exemplary embodiments, the frame portions can be injected molded and formed into singular uniform pieces. The ridges 33 and interior portions can additionally have a texture to provide a greater surface area to form a bond between the adhesive and the frame portions 30 and/or the core portion 20. The two frame portions 30 can fully encase the core portion of the paddle apparatus. In some exemplary embodiments, a handle portion of the core portion may only extend a predetermined distance of the handle portion of the frame portions.

In some exemplary embodiments, a bottom cap portion 50 can be applied at the bottom end of the grip portion of the frames after the two frame portions 30 are coupled together. The bottom cap 50 can provide additional rigidity to the paddle assembly as well as provide a contoured area to help with a user's ability to keep the paddle from laterally moving during use. A grip portion can have a secondary grip 40 formed over the top of the frame 30 or alternatively wrapped around the frame 30 using any suitable grip wrap.

Exemplary embodiments of a paddle assembly 1 are further illustrated in FIGS. 2A-D. The frame components 30 can be configured to approximate the perimeter sidewall and edge of the core portion 20. The frame portions can have a sidewall 32 that extends a predetermined length. In some exemplary embodiments, the frame sidewall 32 can extend at least halfway down the sidewall 22 of the core portion. When positioned on each side of the core portion 20, a groove/channel 34 can be formed around the perimeter of the core 20. The optional film layer can either permanently or removably couplable to the surface of the paddle playing surface.

Additionally, a perimeter edge portion 31 can extend generally perpendicular from the edge of the frame portion 30. The overhanging perimeter edge portion 31 can extend over a portion of the surface around the head portion 3 of the paddle assembly as shown in FIG. 2B. A secondary adhesive 90 can be applied around the perimeter edge portion 31 of the two frame portions 30 to couple them together around the core 20. Similarly, the over grip portions 40 can also be coupled to the frames portions 30 using an adhesive around the perimeter edge and/or on the surface of the grip portion of the frames 30.

A cross-section of a handle portion 2 of an exemplary embodiment of a paddle assembly 1 of the present disclosure is illustrated in FIGS. 2C-D. One of the frame portions 30a can have an underhanging portion 36 that extends a pre-determined distance past the edge 35 of the corresponding frame portion 30. The corresponding frame portion 30 can have an opposite overhang portion 38 that can extend past the corresponding edge 35. The corresponding overhanging portions 36,38 can allow for the frame portions 30 to be utilized with varying thicknesses of core portions 20. Additionally, the corresponding overhanging portions 36, 38 can conceal the core portion 20 from being viewable from the exterior. In the grip portion of the frames can be additional support member 33 that can contact and support the frame against the core 20. In some exemplary embodiments, the grip 40 can be an over molded grip or a separate grip component that can be coupled to the over the grip portion of each frame. In some exemplary embodiments, the grip 40 can be a wrap that can be coupled to the grip portions 45 of the frames as shown in FIG. 2E. Alternatively, the grip can be over molded over the grip portions 45 of the frames or a grip wrap can be applied over the grip portions 45 of the frames 30.

An adhesive 80 can be applied to the top edge 42 of each grip portion 40 to couple the first grip portion 40a to the second grip portion 40b and onto the core 20. Alternatively, the over grip portions 40 can be thermoformed around the handle portion of the frame portions 30 or be coupled to the grip area of the frames assembly in to separate over grip portions 40a,b as shown in FIG. 2D. In some exemplary embodiments, an adhesive 80 can have elastomeric properties to provide sound and vibration dampening.

FIG. 2D illustrates a cross-section along axis B-B of the side portion of the paddle assembly 1 where the two frame portions 30 can be coupled. Similar to the handle portion 2, one of the frame portions 30a can have an underhanging portion 36 that extends a pre-determined distance past the edge 35 of the frame portion 30. The corresponding frame portion 30 can have an opposite overhang portion 38 that can extend past the edge. The corresponding overhanging portions 36, 38 can allow for the frame portions 30 to be utilized with varying thicknesses of core portions 20. Additionally, the portions 36, 38 can conceal the core portion 20 from being viewable from the exterior.

When the two frame components 30a,b are positioned on each side of the core 20 the frame portions can be coupled to the core 20 using any suitable means. In one exemplary embodiment, the frame portions 30 can be coupled to the core portion 20 using an adhesive 80 applied to the core portion 20 and/or the frame portions 30. Alternatively, an adhesive 80 can be applied along the overhanging portions 31 of the frame portions 30 as well as the perimeter edge joint channel 34 between the two frame portions 30. Additionally, the two frame portions 30 can utilize an adhesive 80 applied on the edges of each frame 30a,b to adhere the frame portions 30 together. In some exemplary embodiments, the adhesive 80 can form a thermos-bond between the components and result in a solid component. In other exemplary embodiments, the frame portions 30 can be thermos welded/bonded together. This coupling method can increase both structural rigidity of the frame and the paddle assembly 1 as a whole. The additional adhesive, glue, or other coupling means 80 can be utilized to couple the frame portions 30 to each other. In some exemplary embodiments, the adhesive 80 can have additional shock absorption properties to help with the functionality of the paddle apparatus of the present disclosure.

An adhesive 80 can be applied to the entire perimeter edge 35 of each frame portion 30, the ridge portions 33, and the overhanging portion of the frame to bond the core 20 and frame portions 30 together. An exemplary embodiment of the present disclosure can have both bonds between the two frame portions 30 as well as bonds between the frame portions 30 and the core portion 20. Excess adhesive 80 can get into the sides of the core portion 20 and add additional bonding and structure between the components. A thermal bonding adhesive can result in additional structural rigidity between all components of the paddle apparatus.

As shown in FIG. 2E, an exemplary embodiment of an over grip portion 40 can have a top surface 22 and side surface 24 on each side of the over grip portion 20. The top surface 22 of the grip 40 can have a patterned surface or ridges 25 to provide greater grip by the user and prevent the paddle from twisting within the user's hand. In one exemplary embodiment, the pattern 25 can be in the form of ridges oriented in a generally vertical orientation along the grip surface 22. Similarly, the side surfaces can have a texture/ridge pattern. In some exemplary embodiments, the texture/pattern of on the side surface can be ridges formed generally horizontal in nature in relation to the length of the handle portion 2. The ridges on the side surface 24 can prevent/limit the ability of the paddle from slipping out of a user's hand.

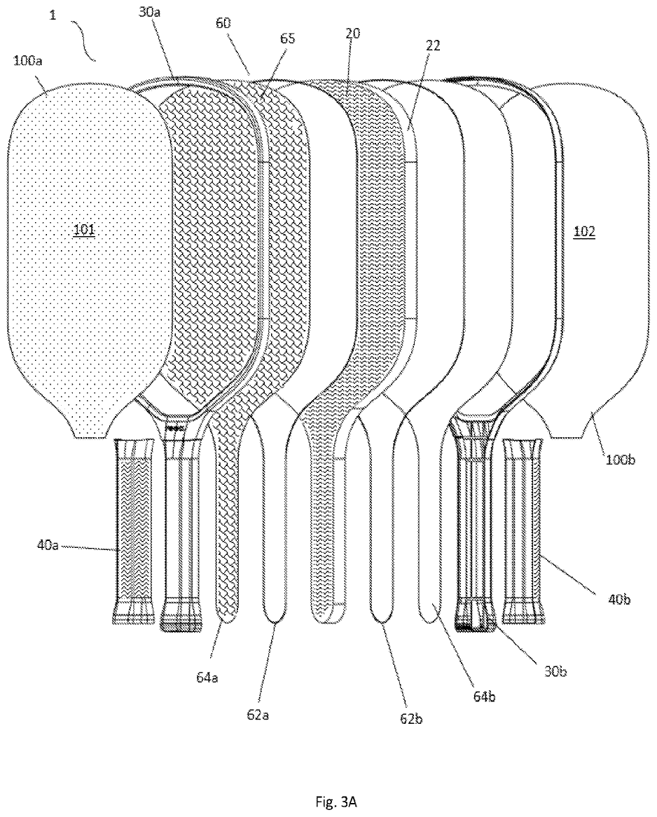

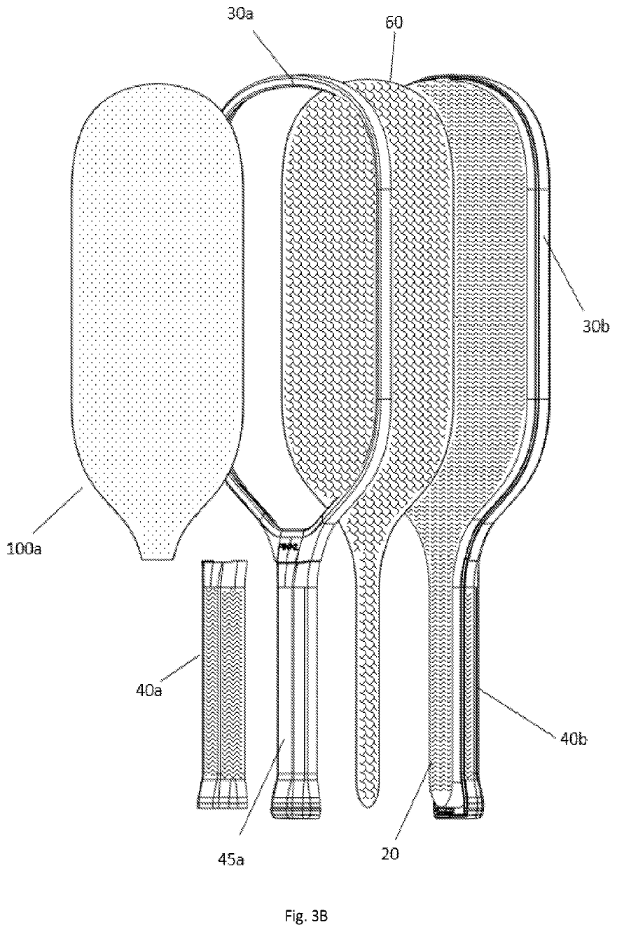

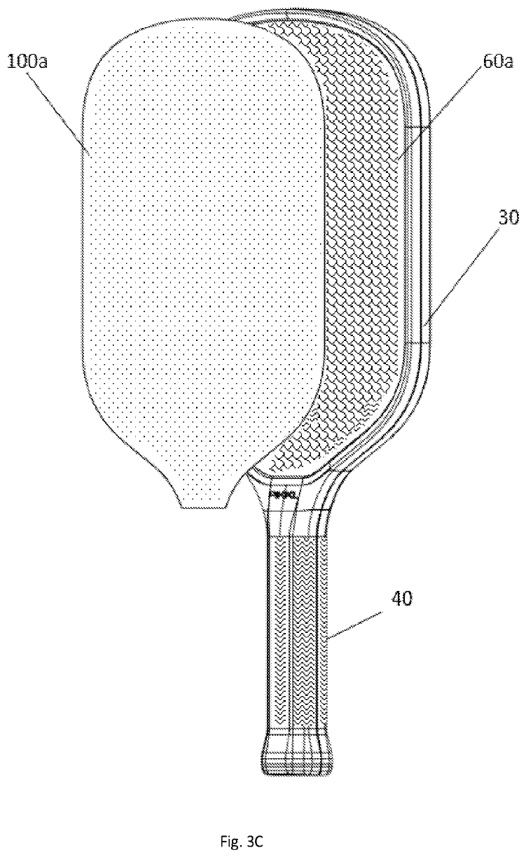

As shown in FIGS. 3A-C, some exemplary embodiments of the paddle assembly can include a primary core member 20 that can be comprised of any suitable material. The core portion 20 can have a first side 21 and a second side 23 and a sidewall 22 that forms the entire perimeter edge of the core portion 20. The core 20 can be any thickness and any material. In some embodiments, the core can be comprised of polypropylene, carbon fiber, or any other suitable material. In some exemplary embodiments, the core portions 20 can be between about 10 mm to about 50 mm of any suitable alternative. The core portion can be formed with a closed edge and utilize a two piece over molded handle over grip 40. The two frame portions 30 can encapsulate the core portion 20 around the perimeter edge of the core of the paddle assembly 1. Two frame portions 30 can be coupled to the core 20 utilizing an adhesive layer 80 that can be applied to each side of the core 20. An adhesive 80 can be any suitable adhesive. In some exemplary embodiments, the adhesive 80 can be a PSA. The first grip portion 40a and the second grip portion 40b can be positioned around the hand end of the core 20.

In another exemplary embodiment a paddle assembly 1 can include the core portion 20, a first and second frame component 30a,b, a first layer or skin 60 that can be applied to each surface of the core portion 20. In some exemplary embodiments the first layer 60 can include an adhesive portion 62 and a skin portion 64 as shown in FIG. 3A. The adhesive portion 62 can allow for the first layer to be coupled to the core portion In other embodiments, the first layer 60 can include just a skin portion 64 that can be thermo-welded, sprayed onto, or formed to the core portion 20. The first layer 60 can have a top surface 65. In some exemplary embodiments, the top surface 65 of the first layer 60 can have a texture. The texture can be any suitable texture to provide a coefficient of friction against an object such as a ball. The texture can apply an amount of spin or force against the object. The first layer can be comprised of any suitable material including but not limited to a soft TPU mater, PET, or other polymer material. The textured surface of the first layer 60 can be applied using a coating, rolling, embossing, or other suitable method. In some exemplary embodiments, the first layer can be comprised of a material with a high coefficient of friction against an HDPE object.

A first layer 60 can be incorporated into the core portion 20 or form the top surface of a core portion 20. The first layer 60 can have a first surface texture that can have prescribed roughness and/or COF. The surface texture can be applied or incorporated into the first layer 60 through embossing the surface during production of the first layer 60. In some exemplary embodiments, the first layer 60 can be applied to the core portion 20 prior to the frame components 30 being applied. An adhesive 62 can be used to bond the first layer 60 to the surface of the core portion 20. Alternatively, the first layer 60 can be thermo18-welded to the surface of the core portion 20. The panel 60 can be of any suitable material, including but not limited to polypropylene that can be corona treated to allow for the panel 60 to be printed on and provide various ability for a user to add graphics prior bonding to the core portion 20.

The first layer 60, and the core 20 and panels can both be comprised of a first same material, including but not limited to polypropylene. In other exemplary embodiments, the components can be comprised of a TPU material. The TPU material can have a durometer between about 60 Shore A and 60 Shore D. An adhesive layer 80 can be applied to couple the first layer 60 to the core 20. An adhesive layer 62 can be any suitable adhesive. In one exemplary embodiment, the adhesive layer 62 can be a thermally bonded adhesive that thermally bonds the first layer 60 to the core 20 to provide greater structural rigidity and stability between the two components and also preventing delamination of the first layer 60 from the core. Additionally, where the first layer 60 and core 20 are both comprised of polypropylene the entire structure can be recyclable unlike current paddles on the market comprised of various non-recyclable components. Similarly, the secondary film assembly 100 can additionally be comprised of recyclable materials given the disposable nature of the item.

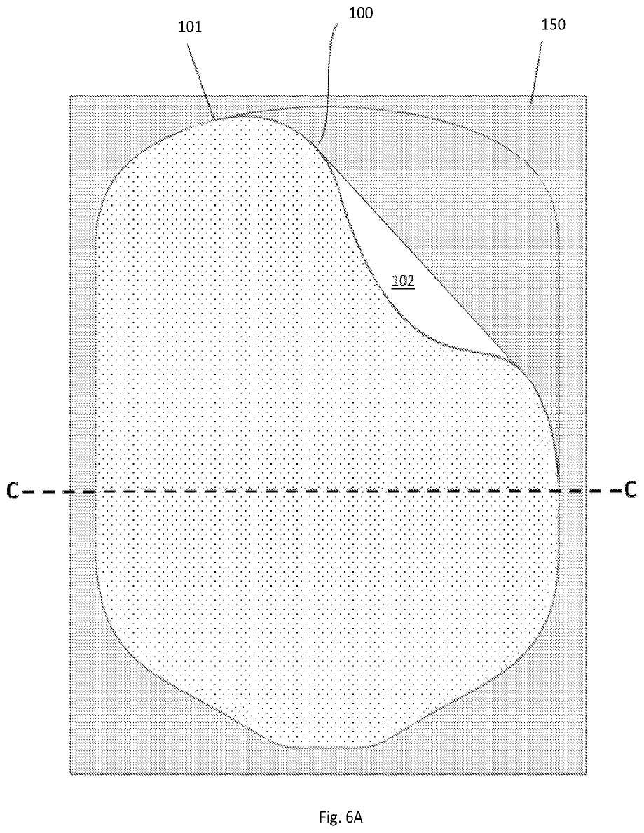

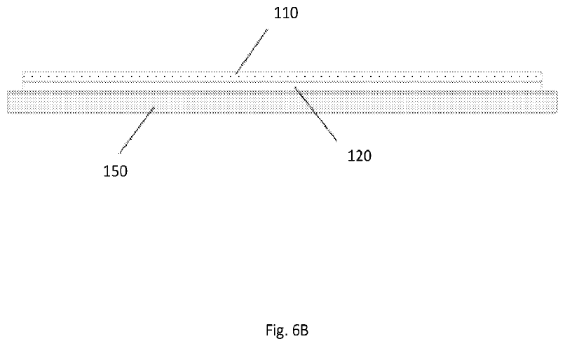

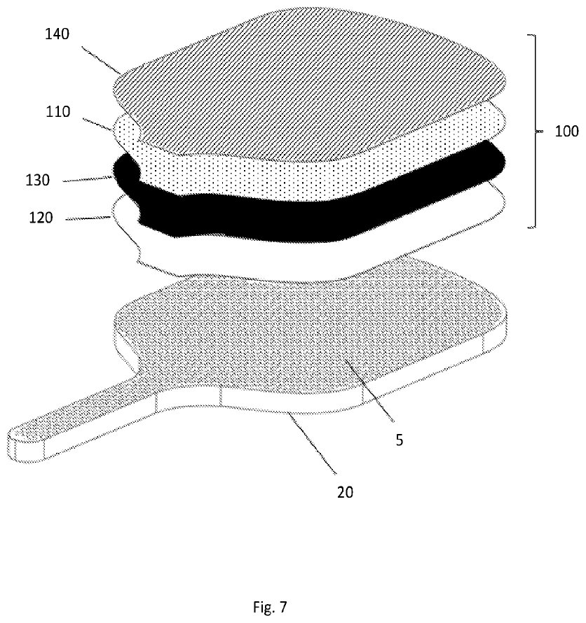

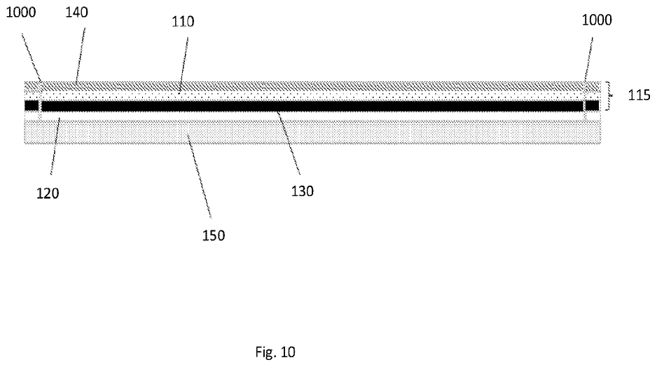

The paddle assembly 1 can further include an optional secondary film assembly 100. The secondary film assembly 100 can be comprised of one or more components. A secondary film assembly 100a,b can be applied on each side of the head portion surfaces 5a,b. The secondary film assembly 100 can be removably couplable by a user to allow a user to apply and remove the secondary film assembly 100 to the paddle assembly 1 when desired. The secondary film assembly 100 can have a first surface 101 and a second surface 102. The first surface can be a playing or wear surface that contacts objects, such as a ball and the second surface can be an interior surface that is applied against a playing surface of a sports implements, such as a paddle. In some exemplary embodiments, the second surface can be an a second side of an adhesive layer 120 to couple the secondary film assembly 100 to a playing surface 5 of a sports implement 1. Alternatively, the interior surface 102 can be removably coupled to a release liner as shown in FIGS. 6A-B and FIG. 10. The first surface 101 can have a texture or a coefficient of friction capable of applying spin to an object. The second surface 102 can include the second side 122 of the adhesive layer 120 having. The adhesive layer 120 can allow for repositioning and reapplication of the skin assembly 100 to a paddle surface and back to a release liner or to reposition the assembly 100 to ensure a proper alignment on the paddle surface 5.

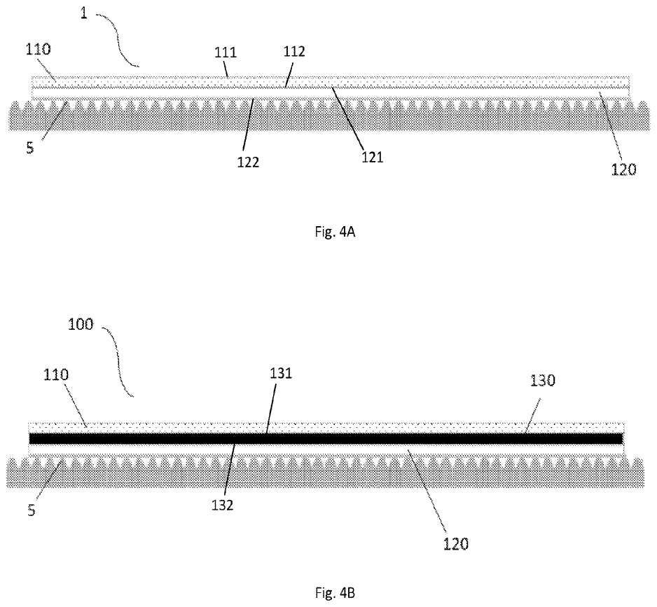

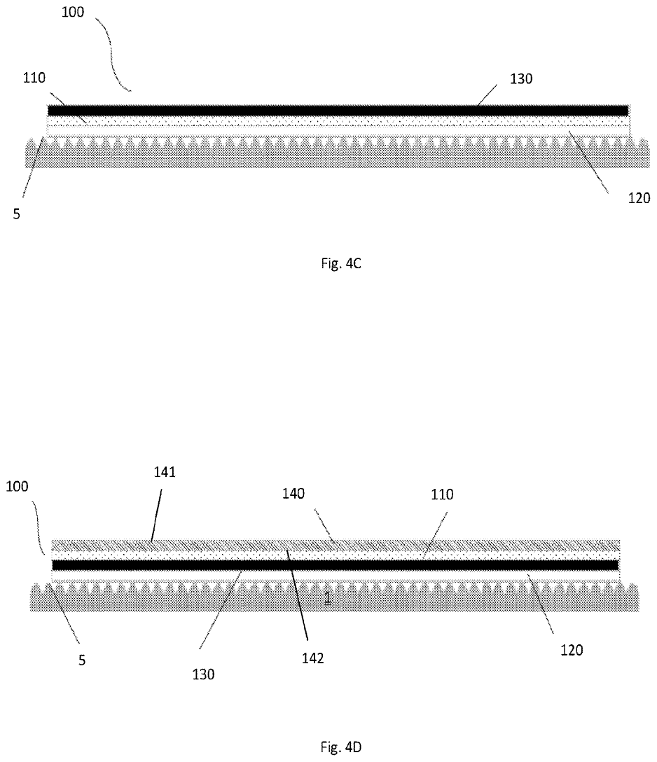

In one exemplary embodiment, the removable secondary film assembly 100 can include a base or film layer 110 and an adhesive layer 120 as shown in FIG. 4A. The adhesive layer 120 can be a single layer of a singular adhesive material with viscoelastic properties. In some exemplary embodiments, a secondary film assembly 100 can have one or more graphic layers 130 to allow a user to easily change the appearance of the paddle assembly 1.

In some exemplary embodiments, a pressure sensitive adhesive can have elastomeric properties that provide for not “wetting out” into the various ridges or crevices of a textured surface while also having suitable tack to removably couple the assembly 100 to a paddle surface without leaving adhesive to the paddle surface. In one exemplary embodiment, elastomeric properties of an adhesive that can be used as an adhesive layer 120 of the secondary film assembly 100 can be relatively stiff to limit the ability of the adhesive layer 120 from creeping into or flowing into the textured valleys of a paddle surface 5. As shown in FIGS. 4A-4D, the adhesive layer 120 can primarily only bond with the peaks or top plane of the textured surface 5 of a sport implement 1 due to the relatively stiff or dry properties and the thinness of the adhesive layer 120. The adhesive layer 20 can span the valleys without wetting into the grooves thereby having a lower bond strength to the textured surface. This prevents omnidirectional growth or spread of the adhesive layer when contacting a rough surface, such as the paddle surface 5. The rigid first layer 110 further supports the adhesive layer 120 due to having a strong bond strength to the smooth surface of the fist layer 110. In some exemplary embodiments, the first side or surface 111 of the film layer 110 and a second side 112 of the film layer 110 can have two different coefficient of frictions and/or roughness. The roughness of the first side 111 can be greater than the roughness on the second side 112 of the first layer 110. In other exemplary embodiments, the roughness can be equal to each other. In some exemplary embodiments, the second side 112 of the film assembly or second side 132 of a graphic layer 130 will have a lower roughness than the roughness of the paddle surface 5.

The adhesive layer 120 can include a single layer of adhesive 120 to ensure that the weight of the adhesive does not detrimentally affect the playability of the paddle having the skin assembly 100. In some exemplary embodiments, the adhesive layer 120 can be comprised of a non-differential and non-supported PSA. The roughness of the paddle surface 5 is greater than the roughness of the bonding surface 103 of the film assembly 100 to allow for the adhesive to maintain a stronger bond to the bonding surface 103 allowing for a clean removal of the film assembly 100 from the paddle surface 5. Unlike traditional PSA adhesive systems, a single layer non-differential pressure sensitive adhesive of the present disclosure allows for the assembly 100 to utilize a minimal amount of adhesive to further reduce the weight of the assembly 100. It additionally, allows for a thinner overall film assembly 100.

By reducing the weight of the assembly 100 undesired effects of weight that affect playing characteristics of a paddle can be minimized with a paddle assembly 1 having a secondary film assembly 100 of the present disclosure. The utilization of a singular non-differential adhesive layer allows for a very thin adhesive layer to ensure no bond confusion between the bonding surface of the secondary skin assembly and a textured object surface. The use of a thinner adhesive layer also reduces weight to the paddle assembly that could negatively affect performance. The adhesive can contact the surface area on the top plane of the object or paddle surface creating minimal contacts, whereas the adhesive layer 120 completely contacts the flat surface of the bonding surface of the secondary film assembly 100.

A non-differential pressure sensitive adhesive layer 120 can have a singular adhesive coefficient. As shown in FIGS. 4A-4D, an adhesive layer 120 can be a comprised of a film layer with stiffness capable of sitting on top of a textured surface rather than migrating into the textured grooves or indentations like a traditional adhesive. This non-differential pressure sensitive adhesive layer 120 can have a greater binding affinity to the flat surface on the second side 112 of the film layer 110 due to a higher amount of surface area as it sits on top of the surface of the textured surface of the paddle surface 5. The adhesive layer 120 can thus have a lower binding affinity to the rough or textured paddle surface 5 providing for easy a clean removal of the skin assembly 100 after it has been applied to a paddle surface 5. The film layer 110 and adhesive layer 120 in some exemplary embodiments can generally be a clear or transparent materials. This can allow any graphic that previously exists on the paddle surface to show through the skin assembly.

In some exemplary embodiments, the structural aspects of the surfaces rather than chemical properties (adhesive coefficient) can allow the adhesive layer 120 to have a greater bonding affinity to the second surface of the film/base layer than to the surface of the paddle assembly and/or release liner. An exemplary embodiment of a stiff adhesive layer 120 of the present disclosure is between about 0.6 mil and 2 mil in thickness on a rigid film layer 110 allows a user to easily couple the secondary film assembly 100 to a paddle and then remove the secondary skin assembly 100 from the paddle without the adhesive layer 120 remaining on the release liner or the surface 5 of the paddle assembly. The adhesive layer 120 has a greater bonding strength to a flat surface with little to no roughness due to the adhesive surface 120 contacting a greater surface area.

A first surface 101 can have a coefficient of friction as it relates to impacting an object. In some exemplary embodiments, the object can be comprised of HDPE. In some exemplary embodiments, the texture on the first surface 101 can have a maximum roughness of about 40 RZ and 50 RT in order to apply spin and have a high coefficient of friction against a HDPE object. In other exemplary embodiments, the first surface 101 can be comprised of a high coefficient of friction material, including but not limited to TPU, rubber, or other material, to apply spin the object by exerting a high coefficient of friction. Additionally, embodiments utilizing a high coefficient of friction material can additionally have a high roughness.

In some exemplary embodiments, a contact surface 101 of the film layer 110 can have a coefficient of friction between about 0.1 to about 0.5 or about 0.15 to about 0.19, or less than about ≤0.5 when tested according to ASTM D1894-14. In some exemplary embodiments, the surface texture of the first surface 101, the roughness shall be an average of no greater than about 40 micrometers (μm) on the Rz readings (average maximum height, peak to valley) and an average of no greater than about 50 micrometers on the Rt readings (maximum height, peak to valley), with all readings to be taken in six different directions using Starrett SR160 Surface Roughness Tester. Similarly, the core portion itself and/or the skin layer 60 can have similar surface textures as referenced herein to allow the adhesive layer 120 to be removably couplable to the paddle impact surface 5. The roughness of the second side 112 of the film layer 110 or graphic layer 130 is less than the roughness of the paddle surface 5 to which the secondary film assembly 120 is to be coupled.

The contact surface 101 can have a high COF and low roughness or high roughness with low COF in accordance with IAW ASTM D1894-14 testing standards. A smooth surface with low roughness can still provide a high COF to adequately apply a spin against when the materials or composition of the film layer 110 has a high coefficient of friction. Similarly, a rough surface with low COF can still have high COF against an object in the ASTM D1894 test due to the texture of the low COF material. The second surface 112 of the film layer can have a very low roughness to ensure a strong bonding interaction with the adhesive layer 120. The first surface 111 of the film or contact surface 101 can be comprised of various types of materials configured to provide a coefficient of friction between about 0.01 and 0.40 against an object with a relatively low roughness or smooth surface such as a ball. In one exemplary embodiment, the first surface can have a high roughness, or a similar roughness to the paddle surface 5.

A film layer 110 can be a clear or transparent material that can have a first surface 111 and second surface 112. The secondary film assembly 100 can be applied to a playing surface 5 of a sports implement. In some exemplary embodiments, the playing surface 5 can be the top of the panel 60 or core portion 20 surface material that may contain preexisting graphics. The clear film layer 110 can allow for the preexisting graphics to show through the film assembly 100. While the core portion 20 can have a graphic or design printed direction onto the core portion 20, some exemplary embodiments of the secondary film assembly 100 can include a graphic or printed design layer 130. The one or more graphic layer 130 can be applied to second surface 112 of the film layer 110. The graphic layer 130 will generally take the same roughness as the second surface 112 of the film layer. The graphic layer 130 can have one or more pigments. In some embodiments, a plurality of graphic layers 130 may be necessary to prevent bleed through or see through of the original graphics on the paddle surface 5.

The secondary film assembly 100 can be of any suitable material, including but not limited to polypropylene or TPU that can be corona treated to allow for the first layer 110 to be printed on and provide various ability for a user to add graphics or one or more graphic layers 130 prior to a the application of the adhesive layer 130 to allow for the assembly 100 to be applied over a surface 5 of the paddle. In some exemplary embodiments, a secondary film assembly 100 can be configured to accept ink from an printing processes including but not limited to an inkjet printer, wherein the ink is absorbed into the second surface 112 of the film layer 110. Any suitable ink can be used for the graphic layer 130. In some exemplary embodiments, a UV-cured ink can be used for the graphic layer 120. Applying the graphic layer 130 to the second surface 112 of the film layer 110 allows for the graphic to be protected from external impacts and wear.

A film layer 110 of the secondary film assembly 100 can be comprised of any suitable material. In one exemplary embodiment, the film layer 110 can have a hardness between about 50 Shore D and 150 R on the Rockwell scale, or between about 90 R-150 R. The film layer 110 can have a desired hardness to provide a rigid enough carrier layer to be applied to an adhesive layer 120. Additionally, the first surface 111 of the film layer 110 can have a coefficient of friction between 0.05 and 0.4.

In one exemplary embodiment, the film layer 110 can be a thermoplastic polyurethane (TPU) material. The second side 112 of the film layer 110 can have a first roughness that is less than the roughness of a paddle surface 5. In some exemplary embodiments, the durometer can be non-elastomeric in nature. A TPU film layer 110 can be advantageous over current embodiments as TPU has a high abrasion resistance and does not easily wear during use. Additionally, since the TPU material can be clear or transparent, it can be applied over a pre-existing graphic rather than having a graphic printed over the top that would normally diminish the textured surface and reduce the coefficient of friction of the surface.

In another exemplary embodiment, the secondary film assembly 100 can be a comprised of a second material, including but not limited to a polycarbonate film layer 110 that can have a first adhesive 120 with a first adhesion factor that is stronger to the polycarbonate film than to polypropylene, carbon fiber, or other surfaces. This can be different than the adhesive used between the polypropylene components. On the first side 111 of the film assembly 100 a texture having a desired coefficient of friction or grit can be imprinted, UV printed/cure, or embossed into the film during manufacturing. The texture can be applied to the first surface 111 of the first layer 110 using an embossing method. In some exemplary embodiments, the first surface 111 texture can be applied using a peel-ply embossing method.

The film layer 110 can be configured to accept a printable ink on the second surface 112 and have a texture on the first surface. In some exemplary embodiments, the ink can be an eco-solvent that can be absorbed into the surface of the skin layer. In other embodiments, a UV printable ink can be used to cure the ink to the second surface 112 of the film layer 110. The polycarbonate material can have a coefficient of friction between 0.05 and 0.4 on the first surface. A polycarbonate material can additionally have a Rockwell hardness between about 30 and 200, ASTM D785.

In some exemplary embodiments, the second surface of the film assembly can be the bonding surface 103 between an adhesive layer 120 and the film layer 110 or graphic layer 130. In some exemplary embodiments, the bonding surface 103 can be the second surface 112 of the film layer or the second surface of the graphic layer 130. The second side 112 of the secondary film layer 110 can be coated with an adhesive layer 120. A release liner 150 can be applied to the adhesive layer 120 to allow for storage of the secondary film assembly 100 and to prevent dust or dirt from contaminating the adhesive layer 120 until it is applied to a surface of a paddle. The complete secondary film assembly including the film layer 110 and adhesive layer 120, but not including the release liner 150, can be between about 4 mil to about 8 mil in thickness, or between about 5 mil to 7 mil in thickness. One exemplary embodiment, the secondary film assembly is less than 7 mil in thickness. Additionally, the individual secondary film assemblies 100 will have a weight between about 0.1 oz and 0.6 oz, or about 0.2 oz to about 0.4 oz, or about 0.4 oz. In some exemplary embodiments, a secondary film assembly 100 weighs equal to or less than 0.3 oz.

The first side 111 can have a prescribed texture. A texture can be sprayed on or alternatively formed into the surface of the first side 111 of the film layer 110. In some exemplary embodiments, the prescribed texture can take a specific geometric configuration or can be randomly created on the first surface 111. The film layer 100 can have a texture pattern with a roughness of between about 20 to about 80 RT, or between about 40-60 Rt, or about 50RT on the first side 111. In some exemplary embodiments, the first side 111 of the film layer 110 can have a maximum roughness of about 50 Rt and 40 RZ. A maximum coefficient of friction of the first surface 111 of the film layer 110 can be about 4.0. Similarly, the surface 5 of the paddle face portion can have a similar or different pattern or texture as the first surface 111. The second surface 112 of the film layer 110 can have a smooth or flat surface with little to no texture. In some exemplary embodiments, the texture and or roughness of the paddle surface 5 is greater than the texture of the second surface 112 of the film layer 110.

The adhesive layer 120 can then be applied to the second surface 112 of the film layer. The adhesive layer 120 can be between about 0.6 mil and 2.0 mil, or between about 0.8 and 1.5 mil, or less than 1 mil in thickness. If the adhesive layer 120 is too thick, it can result in the adhesive layer 120 having bonding confusion between the bonding surface 103 of the film layer 110 or graphic layer 130 and the paddle surface 5. An adhesive that is too thick and/or two soft can have omnidirectional movement or creep into the perforations or indentation of the textured paddle surface 5 thereby creating an unwanted increased bonding affinity to the paddle textured surface than the smooth surface of the film assembly. By utilizing a thin adhesive layer 120, less adhesive material is able flow into the texture resulting in more surface contact with the flat or smooth surface of the film layer and less surface contact with the textured surface of the paddle surface 5 or release liner 150.

FIG. 4B provides a cross-section illustration of a secondary skin assembly 100 having a film layer 110, one or more graphic or ink layers 130, and an adhesive layer 120. The graphic layer 130 can be comprised of one or more graphic layers or passes. The graphic layer 130 can have a first side 131 and a second side 132. The first side 131 can interface with the second side of a first layer 110. The second side 132 can interface with the adhesive layer 120. Similar to the above, the film layer 110 and adhesive layer 120 can be generally the same or have similar properties. One or more graphic or ink layers 130 can be positioned in between the second surface 112 of the film layer 110 and the first surface of the adhesive layer 120. The graphic layer 130 can generally be applied to the second surface 112 of the film layer 110 and maintain the same roughness or coefficient of friction of the second surface 112. In some exemplary embodiments, the graphic layer 130 can be as smooth or smoother than the second surface of the film layer 110. In other embodiments, the graphic layer 130 can be rougher than the second surface 112 of the film layer, but still smoother or have a less roughness than the paddle surface 5. This can further ensure that the adhesive layer 120 maintains a stronger bond to the graphic layer 130 than to the paddle surface 5 to allow for easy application and removal of the skin assembly 100 to the paddle surface.

Unlike the current state of the art that utilizes graphic on the exterior surface, the graphic layer 120 of the skin assembly 100 of the present disclosure does not negatively affect the performance of the film layer that would ordinarily create less friction and also created an easier wear area of the exterior surface. Due to this decreased performance of exterior printed graphics and ink, the current state of the art only allows for printing on the exterior edges or peripheral portions of the paddle surface so as to not negatively impact paddle surface performance. Exemplary embodiments of the present disclosure allow for maintained or improved performance of the first surface 111 of the film assembly 100 while also providing a full edge to edge printing capable graphics on the secondary film assembly 100.

Furthermore, in some exemplary embodiments, an adhesive layer 120 can be non-transparent or have a pre-pigmented/additive color throughout the adhesive layer 120. The pigmented adhesive layer can be between about 0.6 mil and 2.0 mil thickness. The adhesive properties and thickness prevent the adhesive layer from “wetting out” or contacting into the grooves of a textured surface thereby forming a strong bond energy with the flat surface of the base layer 110. The pigmented adhesive 120 can reduce the required thickness or number of passes to establish the graphic layer 130 by reducing the amount ink needed to produce the graphic layer 130. This can further ensure the secondary film assembly 100 does not increase the weight of the paddle assembly and 27 negatively affect the playing capabilities of a paddle assembly 1 utilizing a secondary film assembly 100. Additionally, it reduces the cost of the secondary film assembly 100 by reducing both the amount of ink needed as well as reducing the time needed to print the graphic layer 130. In some exemplary embodiments, the additive color pigment can be a white or off-white primed color to allow for the most flexibility for printing or applying the graphic layer. Alternatively, the pigment of the adhesive layer can mirror the primary color of the graphic layer.

In other exemplary embodiments, the core portion 20 or first layer 60 of the paddle assembly can be pigmented. One embodiment can use a white or off-white pigment to provide a better backing layer for the graphic layer 130 of a secondary film assembly 100. In these embodiments, the adhesive layer 120 can be transparent. Similarly, the present embodiment can reduce the amount of ink required for the graphic layer 120 thus reducing costs, time of manufacturing, and weight. In one exemplary embodiment, a paddle assembly 1 of the present disclosure can include a paddle having a white core 20 or panel 60 on each side of the paddle surface 5 and removably couplable secondary film assembly 100. This provides the ability to print fewer graphic layers 130 on the second side 113 of the film layer 110 to prevent bleeding through while reducing weight of the film assembly 100. In some exemplary embodiments, the paddle surface can have high albedo.

FIG. 4C provides a cross-section illustration of a secondary skin assembly 100 having multiple layers removably coupled to a paddle surface 5. In some exemplary embodiments, the secondary skin assembly can include a base or carrier layer 110, wherein the base layer 110 has a first side 111 and a second side 112. The first side 111 of the second layer can optionally have a textured surface. The second side 112 of the base layer 110 can have a smooth or flat surface. The base layer 110 can be any suitable materials including but not limited to polycarbonate or TPU film. The base layer 110 of the secondary film assembly 100 can be a sound damping material, including but not limited to a polyester non-woven felt. The first surface 11 can include a first coefficient of friction. The coefficient of friction can be determined by one or more of the following, the composition of the first layer, a texture pattern of the first surface 111 of the base layer 110, and additive components applied to the first surface of the second layer. A graphic layer 130 can be applied to the second surface 111 of the base layer 110 using a dye sublimation technique method that allows for a fully printed first surface 11 of the base layer 110 without affecting the way the ball interacts with the surface. Additionally, the dye sublimation graphic layer 130 can also aid in retaining the effectiveness of how the base layer 110 dissipates vibrations.

In some exemplary embodiments, the base layer 110 can be comprised of a non-woven polyester felt material. The base layer can have a first surface and a second surface. The first surface can generally be the playing or exterior surface of the base layer that will traditionally impact an object. The second surface can be the interior surface of the base layer that can have an adhesive layer 120 can be applied to the second surface of the base layer 110. The adhesive layer 120 can interface with the fibers of the felt material to form a strong bond affinity to the felt material. The secondary film assembly 100 comprising a felt base layer 110 can be initially coupled to a release liner The adhesive layer 120 can be a PSA that can coat the entire surface of the felt material and seep into the individual strands of the felt material to form a high surface energy bond to the second surface of the felt material that to the paddle surface to which the secondary film assembly 100 will be removably coupled to. The contact area for the adhesive layer on the second side of the felt base layer 110 can be greater due to fibrous components which can allow the adhesive to sink into the felt structure compared to the paddle or playing surface to which the secondary skin assembly will be removably coupled.

The felt material can additionally have a weight of between about 4.5 oz or about 9 oz, or about 5 to about 7.5 oz per square yard. In some exemplary embodiments, the felt material can weigh no more than 7.5 oz per square yard. The thickness of the felt material can be between about 0.5 mm and 2 mm or about 1 mm thick. In some exemplary embodiments, the felt may not exceed 1.5 mm in thickness. The non-woven felt material can be printable on the first side using any suitable ink. The non-woven polyester-based skin material can provide greater noise reduction when impacting a ball versus traditional skin layers. Additionally, the felt material can still maintain the same hitting and coefficient of friction characteristics desired by a user. The felt material can damp vibration when a ball contacts the surface to under about 600 hz at about 72 db. This substantially reduces the noise created from pre-existing paddles having a traditional playing surface that results in a 1200 hz peak at around 100 db. The felt skin assembly can be applied to pre-existing paddle assembly on the playing surface without detrimentally affecting the playability of a paddle, while simultaneously reducing sound pollution created during ball impact.

The surface of the felt material can have a treatment, including but not limited to a seared, flame, or heat surface treatment. The surface treatment can improve durability of the first side of the felt surface to increase the durability of the felt surface. The flame treatment can fuse together one or more fibers of the felt material at the surface while still maintaining noise reduction properties. The thickness and density allow for a removable skin assembly to be coupled to a pre-existing paddle without adding excessive weight that would affect the playing quality of the paddle. The felt material can use any suitable material, including but not limited to a polyester material. Additionally, in some exemplary embodiments, the felt material will not use additional components including but not limited to bicomponents and be made from a singular component. These additional components may increase the weight of the felt material resulting in an unwanted imbalance when placed upon an equipment surface, such as a paddle playing surface. In some exemplary embodiments, the secondary film assembly 100 can have a base layer 110 comprising a non-woven fibrous material with a thickness between about 0.5 and 1.25 mm in thickness, or between about 0.8 and 1.1 mm in thickness, or about 1 mm in thickness.

In other exemplary embodiments, the base layer 110 can be comprised of a printable texture fabric, woven fabric, thin and lightweight and fabrics that can be coated with certain coatings, including but not limited to a coating component 140 of the first layer. A dye sublimation layer can be used to add a graphic layer 130 to the fabric/felt layer 120 to better maintain the graphic throughout the life of the use of the paddle and prevent the paddle from having less coefficient of friction as traditional UV ink printing creates. Additionally, the fabric material can have textured pattern. The dye sublimation graphic layer 130 can interface directly with the individual fibers of the felt material thereby preventing dye material to mat the surface of the fibers together to ensure the felt still maintains the noise reducing properties. In some exemplary embodiments, the felt material can be comprised of PET or vinyl to absorb the graphic layer into the felt material without matting compressing the fibers of the felt material.

As shown in FIG. 4D, a secondary film assembly 100 can additionally include a coating layer 140 that can optionally be applied to the first surface 111 of the first layer 110. The coating layer 140 can be comprised of a coating that can provide improvements to the surface including, but not limited to increasing the abrasion resistance, improving the wearability, increase coefficient of friction, and reducing the glare of the first surface. The coating layer can have one or more particulates to provide additional surface texture and grit to the first surface 111. A coating layer 140 can go on smooth to allow for the pre-existing surface texture of the first surface 111 to be maintained. In some exemplary embodiments, the coating layer 140 can be applied utilizing a gravure coater or coating apparatus that applies a curable resin. The resin can be cured using any suitable means, including but not limited to air, solvent, or UV curing. In other embodiments, the coating layer 140 can be comprised of polyurethane coating that includes a high coefficient of friction against an object, including but not limited to a pickle ball. The COF can be between about 0.125 and 0.500. In some exemplary embodiments, a coating layer 140 can be between about 2 to about 25 microns thick or about 10 microns thick.

The film or base layer 110 can be a rigid film material having a hardness between about 50 Shore D and 150 R or between about 90 R and 150 R (Rockwell) scale and can operate as a carrier layer for the coating layer 140. The base layer 110 can have some flexibility to allow a user to peel the film assembly on and off a paddle or release liner without losing the shape and form of the skin assembly 100. In some exemplary embodiments, the film layer 110 can be embossed via a roller during extrusion of the material. In one exemplary embodiment, a film layer 110 can be a polypropylene fiberglass impregnated material having an embossed textured surface on the first surface 110 and a flat/smooth surface on the second surface. In some exemplary embodiments, the first layer 110 can function as a carrier layer and can be comprised of a rigid material such as rigid TPU, PET, polypropylene, or other material.

A coating layer 140 can be comprised of a material with a hardness of between about 50 Shore A and 60 Shore D. The coating layer 140 can provide high durability characteristics as well as a high coefficient of friction against an object. The top layer 140 can be coupled to the top surface 111 of the first layer 110 using any suitable material or method. The top layer 140 can be a soft TPU material or alternatively a coating that is sprayed, rolled on, or coextruded to provide a more durable impacting surface and coefficient of friction against an object. An adhesive layer 120 can be coupled to the second surface of the film layer 110, which can allow the secondary film assembly 100 to be removably coupled to a paddle surface 5 or a release liner 150.

The coating layer 140 can optionally also have a textured surface made from a material that has very high hardness but also has a high abrasion resistance when tested to ASTM 1044. The coating layer 140 can optionally include one or more types of particulates to provide a texture to the surface 141 of the coating layer 140. The bottom surface 142 of the coating layer 140 can interface with the first layer 110. The coating layer 140 can have between about 2 mg loss and 100 mg loss abrasion resistance when tested based on 1000 Cycles, 1000 g, CS-17 Wheel, ASTM 1044. A texture can be applied in the coating layer 140 using any suitable means, including but not limited to an embossing applicator or roller or applying the coating to a pre-existing textured surface. The coating layer 140 can provide greater coefficient of friction and durability properties against an object, such as a HDPE ball.

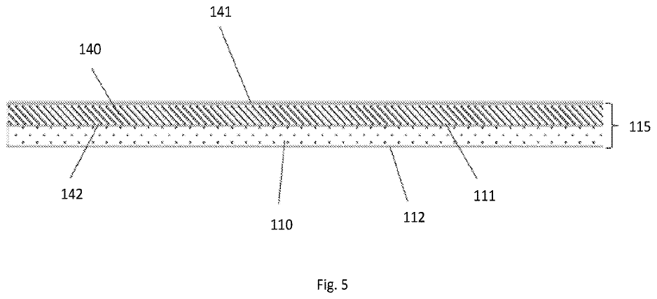

In other exemplary embodiments as shown in FIG. 5, a film layer 110 can be coextruded with a coating layer 140 that is thermally pressed onto the film layer 110 to fuse the film layer 110 and coating layer 140. This can form a laminated film composition 115 comprised of the film layer 110 and coating layer 140. The fused coating layer 140 can be a TPU material. A texture can be embossed on the surface of the coating layer 140 during the coextrusion process of the laminated film 115. Similarly, two film layers can be thermally welded together. The first film layer 110 can have a generally rigid structure while the coating layer or film 140 can have greater coefficient of friction or texture to provide greater spin during impact with a ball. The film layer 110 can be very hard and fairly rigid, while the coating layer provides a wear surface with great durability. Alternative methods can be used to permanently bond the film layer 110 and coating layer 140.

In some exemplary embodiments, the film layer 110 and the coating layer 140 can both be comprised of TPU. The TPU coating layer 140 can have a hardness of between about 50 Shore A and 60 Shore D and the TPU carrier layer 110 can have a hardness of between about 50 Shore D and 150 R or between about 90-150 R (Rockwell) scale. TPU abrasion resistance allows for it to maintain texture while also having a high COF. The coating layer 140 can have a maximum coefficient of friction of 0.50. An adhesive layer 120 can be applied to the second surface 112 of the film layer 110 of graphic layer 130 to where the second surface 112 of the film layer is generally smooth or has a very low roughness to allow the adhesive layer 120 to stay bound to the film bonding surface 103 when being removed from a textured paddle surface 5. The roughness of the second surface 112 is less than the paddle surface 5 resulting in the adhesive layer 130 having a great bond strength the bonding surface than the paddle surface 5.

Similarly, like the laminated film composition 115 that can be used in a secondary film assembly 100 as a film layer 110. As recited above, the laminated film composition 115 can optionally include a graphic layer 130. Additionally, the laminated film composition can be used as a first layer or panel coupled to core portion 20. In this embodiment, the laminated film composition 115 can be permanently adhered or coupled to the core portion. In one exemplary embodiment, the laminated film composition can be thermo-welded to each surface of the core portion. Alternatively, the first layer 140 could be a smooth surface made from a material that has a very high coefficient of friction but also has a high abrasion resistance when tested to ASTM 1044. The second layer 110 can have a compatible chemistry such that the first layer 140 bonds cohesively to the second layer 110 and the second layer 110 provides a flat second surface for bonding to a pressure sensitive adhesive 120. The second layer 110 can have a second surface 112 that is smooth and made from a material that has a high surface area for bonding to pressure sensitive adhesive 120 and a dyne level that will allow printed inks to bond cohesively to the second layer 110 on the second surface 112.

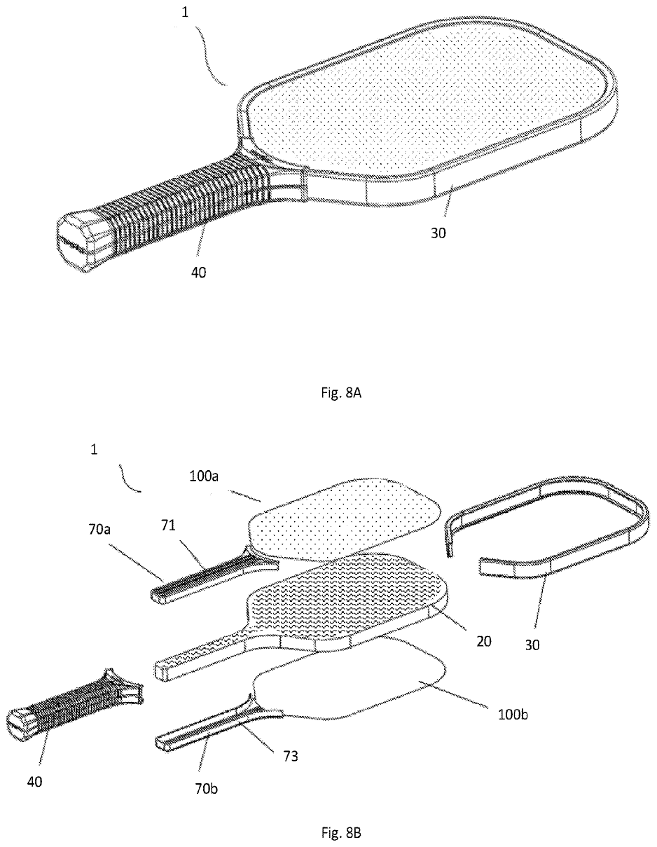

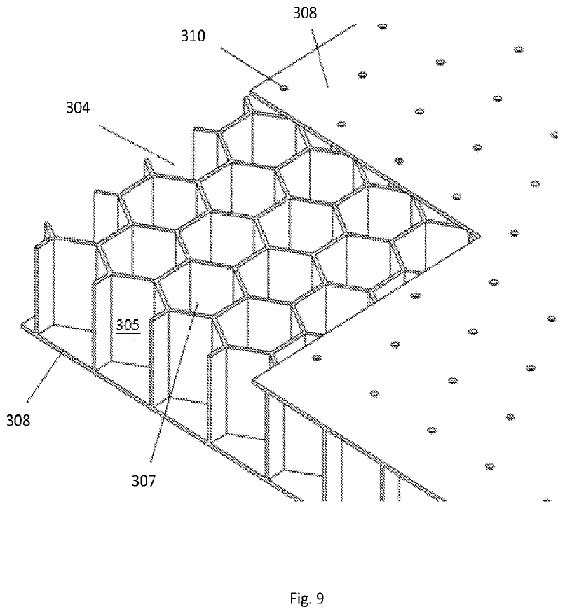

FIGS. 8A-B show an exemplary embodiment of a paddle assembly 1 of the present disclosure. The assembly can include a core portion 20, a frame or bumper portion 30, a grip portion 40, a film layer 10, and one or more grip support members 70. The core portion 60 can have a handle portion and a body portion, a grip support member can be coupled to each side of the handle portion to provide an elevated and round formed layer of the paddle. A removable film assembly 100 can be applied to each side of the body portion of the core to provide a graphic or textured surface to the core body. A frame portion 30 can then be applied around the exterior edge of the body portion of the core. The grip portion 40 can then be coupled over the grip support members and similarly be bonded/coupled to the frame portion 30 to fully surround the core portion. The grip support members 70 can be comprised of a rigid material and can provide additional support to the handle portion 2 at the intersection point with the head portion 3 of the core 20. These support members 70 allow for greater rigidity and minimize the ability of the core to become broken, collapsed or damaged at the intersection point rendering the paddle ineffective or having a diminished playing characteristics. The support members can have a top surface 71 and a side wall 73. The sidewall can extend down generally perpendicular from the top surface and approximate the handle portion 2 of the core portion 20 as shown in FIG. 8B. The support member 70 can be coupled on each side of the core portion. In some exemplary embodiments, the grip support member 70 are thermo-welded to each surface of the handle portion 2 of the core portion 20.

The central support component of the core 20 can take any suitable shape or configuration including but not limited to a hexagonal honeycomb configuration as shown in FIG. 9. The central support component can provide a rigid interior. The sidewalls 305 formed by the honeycomb members can have a predetermined height. The height of the side walls can be between about 2 mm to about 60 mm. The height can be used to establish a thickness of the paddle core. In some exemplary embodiments, the sidewalls can have one or more apertures interconnecting the chambers 307 created by the sidewalls 305.

In some exemplary embodiments, the core portion can be comprised of a central support component 304, a first panel 306, and a second panel 308. Each panel can have a first surface and a second surface. In some exemplary embodiments, the panel portions can have perforations or holes 310. Alternatively, the panels can be solid in construction. The panels can be comprised of any suitable material. One exemplary embodiment can utilize a thermoplastic material for the construction of one or more of the panel portions and central support component including but not limited to polypropylene. The first surface of each of the panels can have a texture. The texture can have a coefficient of friction between about 0.01 and 0.40. The panel portions can have any suitable thickness between about 0.1 mm to about 10 mm. The panel portions 306, 308 can be thermo-welded to the central support 304 component to form the core portion 60.

In some exemplary embodiment, one or more of the panel portions 306, 30 can have aperture/perforations that provide an opening into one or more chambers of the central support component. The perforations/apertures can aid in allowing for sound damping/absorption properties to minimize the sound generated when be hit by a ball. In some exemplary embodiments, none, one or both of the panels can include the perforations. The skin/film layer can be applied to the exterior surface of the panels prior to perforations being formed in the panels. The perforations 310 can take any suitable configuration. In some exemplary embodiments, the first side or first panel can have a first set of perforations prescribed to a first set of chambers and the other side or second panel can have a second set of perforations prescribed to a second set of chambers. The first set of chambers can be identical or can correspond to different chambers than the second set of chambers. In one embodiment, only one side of the playing surface can have perforations while the other side can be solid in construction or alternatively both panels can have perforations. Additionally, in some exemplary embodiments, the paddle assembly can have perforations created upon final assembly on one or more of the paddle surfaces. The perforations/apertures can be formed into the panels after the secondary film is applied to the core portion.

Additionally, the core portions of the present disclosure can be formed from polypropylene. A honeycomb or similar corrugated polypropylene material can be provided and ran through an apparatus while a polypropylene skin/film can then be applied to both sides of the core material through using an thermal head source such as a roller body to form a final rigid core material. The resulting core and skin can be permanently welded/bonded together to form a singular rigid structure. The final core material can then be cut out to any suitable shape and utilized as a core of a paddle assembly of the present disclosure. The core can include one or more layers of film that can be thermos-welded to the core material.

In yet another aspect, the present disclosure provides a method of producing and affixing a removably couplable secondary film assembly 100 for a paddle assembly 1. The film assembly 100 can be produced by providing a film or base layer 110, an adhesive layer 120, and a release liner 130. The base layer 110 can have a first surface and a second surface. The first surface can have a first surface texture and the second surface can be smooth or have little to no texture. An adhesive layer can then be applied to the second surface of the film/base layer. A release liner or release layer can then be applied to the adhesive layer to prevent exposure of the adhesive layer to dust and particulate. The release liner 150 can have a coating such as silicone or similarly a texture greater than the second surface of the base layer to allow for the film assembly 100 comprising the film layer 110 and the adhesive layer 120 from the release liner 150.

The ability of the film assembly 100 to be removed from a paddle face can achieved by the PSA bond differential between the second surface of the film layer or graphic layer and the paddle surface. That bond differential is created by having a texture on the paddle face with less surface area for the PSA to bond to versus the smooth flat surface of the portion to which the adhesive layer is bonded to on the film assembly. The adhesive layer has a greater surface area to bond to on a smoother surface compared to the textured surface due to the non-properties of the adhesive layer. This bond differential allows the adhesive to release from the paddle surface while remaining on the surface of the film assembly.

The film assembly 100 components can be removed from the release liner 150 to apply the remaining components of the film assembly 100 to a paddle surface 5. The paddle surface can have a paddle surface texture. The paddle surface 5 texture can have a greater roughness and/or coefficient of friction than the second surface of the base layer. This can allow a user to easily remove the base layer and adhesive layer from the paddle surface when desired by the user. In some exemplary embodiments, the first surface texture can be applied using a peel-ply embossing method. The film assembly 100 of the present disclosure can be between about 4 and 7 mil thickness. The textured surface of the paddle face can also be configured to allow for “air egress” when applying the skin to the paddle surface. If the paddle surface has a smooth surface, air entrapment will occur between the PSA and paddle face resulting in raised bubbles on the paddle surface.

By using different surface textures on the film assembly and paddle face to create a bond differential (achieving a differentiation in surface energy through a difference in the surface geometry/surface area), a “removeable” PSA chemistry and/or “differential” PSA system comprising of two types of adhesives with a carrier film between the adhesives is not required. This also results in an overall lower PSA weight which is not achievable with a “differential” PSA construction where multiple layers of adhesive and an intermediate carrier film are required. This also prevents PSA “confusion” when using a removeable PSA chemistry in a single layer. Confusion can occur when the film layer is removed from the paddle surface and some of the PSA remains on the paddle face instead of releasing cleanly because the surface energy of the paddle surface is greater than the surface energy of surface of the film assembly coupled to the adhesive layer.

Other embodiments of a paddle assembly 1 can have components all being comprised of polypropylene allowing for the entire assembly 1 to be easily recycled thereby reducing waste and allowing for the reuse of the paddle materials. Additionally, by utilizing polypropylene for all of the materials a singular type of adhesive can be utilized to thermo bond/couple the various component materials together to prevent delamination of the materials and improved structural rigidity between the components. In some exemplary embodiments that include a polypropylene core 20 and first layer 60, the components can be thermobonded together utilizing a heat source to permanently weld the components together. The thermowelded bond can prevent potential delamination that is commonly be found in the current art that utilizes different core compositions and skin components that rely solely upon adhesive bonding of the components.

Similarly, the present disclosure provides a method for forming a laminated film layer component 115 having a first layer and a second layer thereby forming a first side having a first set of properties and a second side having a second set of properties. In one exemplary embodiment, the first layer can have a hardness of between about 50 Shore D and 150 R or between about 90-150 R (Rockwell) scale and can operate as a carrier layer for the second layer 140. The first layer 110 can have some flexibility to allow a user to peel the film assembly on and off a paddle or release liner without losing the shape and form of the skin assembly 100.

A second layer 140 can be comprised of a material with a hardness of between about 50 Shore A and 60 Shore D. The first side of the second layer 140 can be made from a material that has a high abrasion resistance when tested to ASTM 1044. Alternatively, the first side could be a smooth surface made from a material that has a very high coefficient of friction but also has a high abrasion resistance when tested to ASTM 1044. The second side of the laminated skin layer can have a compatible chemistry such that the first side bonds cohesively to the second layer and the second side provides a flat second surface for bonding to a pressure sensitive adhesive 120. The second side can have a second surface that is smooth and made from a material that has a high surface energy for bonding to pressure sensitive adhesive and a dyne level that will allow printed inks to bond cohesively to the second side.

The laminated skin layer component 115 can have one or more graphic layer 130 coupled to the second side 112 of the first layer 110. An adhesive layer 120 coupled to the graphic layer 130. In some exemplary embodiments, a secondary film assembly 100 can include the laminated film layer 115 having the first layer 110 and the second layer 120, one or more graphic layers 130, and an adhesive layer 120. The film assembly 100 can be coupled to a paddle surface 5 or a release liner.

In one exemplary method of producing a film assembly 100 on a release liner 150 of the present disclosure, a release liner 150 can be provided. The release liner 150 can be any suitable material. In one exemplary embodiment, the release liner can be coated or comprised of a material with low adhesive properties such as silicone. An adhesive layer 120 can then be coupled to or applied to the surface of the release liner 150. The adhesive layer 120 can have a thickness between about 0.6 mil and 2 mil, or about 0.8 mil and 1.5 mil, or less than about 1 mil. The adhesive layer can be a singular layer of non-differential adhesive with a singular viscoelastic property through the entire layer 120. In some exemplary embodiments, the adhesive layer 120 can have a stiffness and tackiness to prevent the adhesive layer from wetting into valleys of a textured surface.

A film component 115 or layer can then be provided and coupled to the top surface of the adhesive layer 120 on the release liner 150. The film component 115 can take any suitable configuration, including a singular film layer 110 as shown in FIG. 4A or additionally including a laminated film component having a first layer 110 and a second layer 140. Additionally, the film component 115 can optionally include one or more graphic or ink layers 130 applied to the second side of the film component 115. The one or more graphic layers 130 can be any suitable substrate including an ink or dye layer that can be applied using any suitable printing method.

After the film component 115 is applied to the release liner 150 having the adhesive layer 120. A desired shape for the removably portion of the film assembly 100 can be die cut to approximate the paddle surface playing area resulting in cuts 1000 in the film assembly 100 to allow a desired portion to be removed from the release liner 150 and placed onto a desired playing surface, as shown in FIG. 10. The film assembly 100 can then be removed and placed back on the release liner 150 for future use or storage by a user. This can allow a user to easily change film assemblies 100 based upon the desired graphic layer for a specific event, while also providing the ability to have different levels of surface texture and coefficients of friction on the first surface 101 to effect a prescribed amount of spin on a ball of the film assembly based upon an environmental factor, including but not limited to weather conditions, opponent playing style, and type of ball among other things. In some exemplary embodiments, the paddle assembly 1 can come with a plurality of secondary film assembly 100, wherein the first surface 101 of the film assembly 100 can have different coefficients of friction to affect playability or alternatively with different types of materials on the first surface 101.

The present disclosure provides a system and method of making a paddle assembly 1 with improved construction, playability, and replaceable components, including but not limited to a secondary film assembly 100. The method can include provided a paddle having a handle portion 2 and a head portion 3. The head portion can have a playing or contact surface 5 on opposing sides of the paddle 1. The contact surface 5 can have a first prescribed roughness or texture. The contact surface can be comprised of a pigmented material, wherein the pigment can be a white pigment. A film assembly 100 can be provided to be removably couplable to one or more of the contact surfaces 5. The film assembly 100 can include a film or first layer 110 and an adhesive layer 120. The first layer can have a first exterior surface 111 and a second surface 112 that can generally be an interior surface. The exterior surface 111 can have a texture or be comprised of a material with a high coefficient of friction.

The interior of second surface 112 can be generally smooth with little to no roughness or texture. The roughness of the second surface 112 can be less than the contact surfaces 5 of the paddle 1. A single layer adhesive non-differential adhesive can be applied coupled to the second surface 112 of the first layer 111. Generally, the adhesive layer 120 can be clear. In some exemplary embodiments, the adhesive layer can have a pigment to provide a contrasting background to the film layer 110. Additionally, a film layer 110 can further include one or more graphic layers 130 coupled to the second surface 112. The adhesive layer 120 can still bond to the one or more graphic layers 130 applied to the second surface 112.

The adhesive layer 120 can have a greater bonding strength to the second surface 110 or the one or more graphic layers 130 due to the smooth surface and having a greater contacting surface area than the contacting surface area of the textured paddle surface 5. This allows the secondary film assembly to be clearly applied and removed from the paddle surface 5 without leaving the adhesive layer 120 on the paddle surface. Additionally, in some exemplary embodiments, the paddle surface can be pigmented to provide a contrasting background. The paddle surface 5 can be pigmented to have a white or off-white background to provide better backing contrast and reduce the number of graphic layers necessary to implement an ideal graphic on the 112 of the first layer. The white or off-white pigment can be integrated into the paddle surface material or applied to the surface of the head portion during manufacturing of the core portion 20.

The paddle system of the present disclosure can have an interchangeable and removably couplable film assembly provides a user the ability to remove and replace the wear surface of a paddle 1. This prevents a user from needing to purchase an entirely new paddle while improving any diminished playability from wear on the paddle surface. The system also provides the ability for a user to quickly and frequently change the ornamental characteristics of the playing surface, by allowing for multiple film assemblies with different graphic components. By utilizing a white or off-white paddle surface, cost and materials are greatly reduced when printing the one or more graphic layers onto the film assembly, thereby also reducing weight.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A removably couplable multi-layer film assembly for coupling to a textured playing surface of a sports implement having a first surface roughness, comprising:
a first attachable portion comprising:
a first layer, wherein the first layer has a first surface and a second surface, wherein the second surface has a second surface roughness, wherein the second surface roughness is less than the first surface roughness;
a pressure sensitive adhesive layer applied to a bonding surface of the film portion, wherein the pressure sensitive adhesive layer is comprised of a singular layer of non-differential adhesive having only one adhesive property on the first side of the adhesive layer and the second side of the adhesive layer; and
a release liner portion including a liner having a first surface and a second surface, wherein the adhesive layer has a great bonding affinity to the second surface of the first layer than the first surface of the liner.

2. The assembly of claim 1, wherein the bonding surface is the second surface of the first layer.

3. The assembly of claim 2, wherein the first layer has a hardness between 50 Shore D and 150 R.

4. The assembly of claim 3, wherein the first surface has a coefficient of friction between 0.1 and 0.5.

5. The assembly of claim 4, wherein the adhesive layer has a thickness between 0.6mil and 2mil and a stiffness to prevent the adhesive layer from moving omnidirectional into one or more valleys of the textured playing surface, wherein the adhesive layer has a greater bonding strength to the second surface roughness than the first surface roughness.

6. The assembly of claim 5, wherein the first surface of the first layer is textured and the second surface of the first layer is smooth.

7. The assembly of claim 6, further comprising a coating layer applied to the first surface of the first layer, wherein the coating layer has a hardness of between 50 Shore A and 60 Shore D.

8. The assembly of claim 7, further comprising one or more graphic layers applied between the second surface of the first layer and the adhesive layer, wherein each of the one or more graphic layers is between 2 and 4 microns thick.

9. The assembly of claim 8, wherein the film portion is comprised of one of the following: polycarbonate or TPU.

10. The assembly of claim 1, wherein the first layer is comprised of a non-woven fibrous felt material having a weight between 4 oz and 9.0 oz per square yard and a thickness of between 1 mm and 2 mm.

11. The assembly of claim 1, wherein the first layer is a laminated film having a first portion and a second portion, wherein the first portion and second portion are coextruded to form the singular laminated sheet, wherein the second portion forms an exterior contacting surface and the first portion forms the interior bonding surface that can provide a semi-rigid carrier surface for the second portion, wherein the first portion has a hardness between 50 Shore D and 150 R and the second portion has a hardness of between 50 Shore A and 60 Shore D.

12. The assembly of claim 11, wherein the exterior surface of the second portion is comprised of a material with a high abrasion resistance with between a 2 mg and 50 mg loss based 1000 Cycles, 1000 g, CS-17 Wheel, ASTM 1044.

13. The assembly of claim 12, wherein the exterior surface of the second portion has a COF of between 0.100 and 0.500 when tested according to ASTM D1894-14.

14. A multi-layer film assembly for coupling to the playing surface of a sports implement, comprising:
a film layer having a first surface and a second surface, wherein the film layer comprises:
a first layer having first side and a second side; and a
second layer having a first side and a second side;
wherein the first side of the second layer forms an exterior contacting surface and the first side of the first layer is contacting the second side of the first layer, wherein the second side of the first layer forms the interior bonding surface that can provide a semi-rigid carrier surface for the second portion, wherein the first portion has a hardness between 50 Shore D and 150 R and the second portion has a hardness of between 50 Shore A and 60 Shore D;
a pressure sensitive adhesive layer applied to a bonding surface of the film layer, wherein the pressure sensitive adhesive layer is comprised of a singular layer non-differential adhesive having only one adhesive property.

15. The assembly of claim 14, wherein the first surface of the film layer is textured and the second surface of the film layer is smooth, wherein the first surface has a COF of between 0.100 and 0.500 when tested according to ASTM D1894-14.

16. The assembly of claim 15, further comprising a graphic layer applied to the second surface of the first layer.

17. The assembly of claim 16, wherein the first side of the second layer is comprised of a material with a high abrasion resistance with between a 2 mg and 50 mg loss based 1000 Cycles, g, CS-17 Wheel, ASTM 1044.

18. A paddle apparatus comprising:
a core portion having a handle portion and head portion, a first side, second side, and a sidewall forming a perimeter edge;
a frame assembly comprising:
first frame portion and second frame portion to approximate the perimeter edge of the core portion,
wherein the first frame portion and the second frame portion are adhered together to form a barrier around the sidewall of the corporation, wherein the adhesive provides structural rigidity and vibration damping;
a grip portion configured to cover a portion of the handle portion of the frame assembly, and
removably couplable secondary film assembly comprising:
a first attachable portion comprising:
a film portion, wherein the film portion has a first surface and a second surface; and
a pressure sensitive adhesive layer applied to a bonding surface of the film portion, wherein the pressure sensitive adhesive layer is comprised of a singular layer of non-differential adhesive having only one adhesive property on the first side of the adhesive layer and the second side of the adhesive layer.

19. The paddle assembly of claim 18, wherein the first surface of the film portion has COF of between 0.100 and 0.500 when tested according to ASTM D1894-14.

20. The paddle assembly of claim 19, wherein the PSA layer has an access notch to remove the film.
